(19) United States
(12) Patent Application Publication
(10) Pub. No.: US 2005/0038971 A1
(43) Pub. Date: Feb. 17, 2005

(54) Adjustment of free storage capacity for improved usage

(75) Inventor: Yasushi Tsukamoto, Fujisawa-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/898,513

(22) Filed: Jul. 23, 2004

(30) Foreign Application Priority Data
Jul. 25, 2003 (JP) 2003-279799

(51) Int. Cl. G06F 12/00

(52) U.S. Cl. 711/170; 711/112

(57) ABSTRACT

The free capacity of a storage device associated with an information processing apparatus is altered so that an application program running on the information processing apparatus and using the storage device may more accurately utilize the free capacity. The free capacity is altered either by (i) storing a dummy file on the storage device of appropriate size to create the new free capacity, or (ii) calculating the new free capacity and reporting the new free capacity to the application program. The free capacity is altered when the free capacity is greater than a first multiple of a predetermined capacity by a first offset value. The new free capacity is calculated by adding to a second multiple of the predetermined capacity a second offset value greater than the first offset value and smaller than the predetermined capacity. The first multiple is greater than the second multiple so that the created free capacity is always less than the original free capacity.

### BACKGROUND OF THE INVENTION

1. Field of the Invention

The present invention relates to the sensing or determination of the free storage capacity in an information processing system. More specifically, the present invention relates to a method, program, and apparatus, for recognizing the actual free storage capacity of the system to avoid certain problems in the prior art and to prevent application programs from erroneously determining that the free capacity is insufficient.

2. Background Art

When an application program running on an information processing apparatus stores a file in a storage device or when a new application program is installed, the application program calls a function of an operating system running on the information processing apparatus to determine the amount of free capacity of the storage device. If the storage device's free capacity is insufficient for the program execution or installation, the initiated action is stopped.

With the progress of technology in recent years, the capacity of storage devices such as hard disk drives is rapidly increasing, and hard disk drives having a capacity exceeding 100 GB per unit are now available. Therefore, while operating systems typically expressed the free capacity of a storage device as a 32-bit integer, more recent operating systems often express the free capacity as a 64-bit integer. See, for example, documentation relating to recent releases of the Windows® and other operating systems from Microsoft Corporation.

In determining the free capacity of a storage device, some application programs apply a return value of the operating system's function to a variable having a bit width smaller than the actual bit width of the return value and recognize the free capacity based on this variable. For example, if the operating system returns a free capacity value of 32.1 GB using a 64-bit integer and this value is applied to an unsigned 32-bit integer variable, the portion of the returned value which is a multiple of 4 GB (2³² bytes) is ignored and the free capacity is erroneously recognized as 0.1 GB.

### SUMMARY OF THE INVENTION

Accordingly, a problem arises that the application program determines that the storage device's free capacity is insufficient and generates an error message, despite the actual existence of sufficient free capacity.

In view of the above, an object of the present invention is to provide a program, method, and apparatus which are capable of solving the above described problem. According to a first aspect, the present invention provides a capacity changing program executing on an information processing apparatus for changing a free capacity of a storage device to be recognized by an application program running on the information processing apparatus. The capacity changing program acquires a reported value of the free capacity of the storage device. If the reported value is greater than a first multiple of a predetermined capacity by a first offset value, the program changes the free capacity value to an altered free capacity value. This altered free capacity value is calculated by adding to a second multiple of the predetermined capacity a second offset value greater than the first offset value and smaller than the predetermined capacity.

According to another aspect of the present invention, the information processing apparatus includes a free capacity acquisition module (or section) for acquiring a reported value of the free capacity of the storage device. The information processing apparatus further includes a free capacity alteration module which first determines if the reported free capacity is greater than a first multiple of a predetermined capacity by a first offset value. If so, the free capacity alteration module changes the free capacity value to an altered free capacity value. This altered free capacity value is calculated by adding to a second multiple of the predetermined capacity a second offset value greater than the first offset value and smaller than the predetermined capacity. A still further aspect of the present invention provides a method of altering the reported free capacity value of a storage device in accordance with the functions of the apparatus and program described above.

In accordance with the present invention, it is possible to prevent an application program using a storage device from erroneously determining that the storage device's free capacity is insufficient.

### BRIEF DESCRIPTION OF THE DRAWINGS

FIG. 1 shows a hardware configuration of an information processing apparatus 100 according to an embodiment of the present invention;

FIG. 2 shows a functional configuration of the information processing apparatus 100 according to an embodiment of the present invention;

FIG. 3 shows a principle of changing a free capacity by a capacity changing program 130 according to an embodiment of the present invention;

FIG. 4 is a flow chart illustrating the operation of the capacity changing program 130 according to an embodiment of the present invention;

FIG. 5 shows some forms of changing the free capacity by the capacity changing program 130 according to an embodiment of the present invention, in which FIGS. 5(a), 5(b), 5(c), and 5(d) show first, second, third, and fourth forms, respectively;

FIG. 6 shows additional forms of changing the free capacity by the capacity changing program 130 according to an embodiment of the present invention, in which FIGS. 6(a) and 6(b) show fifth and sixth forms, respectively; and

FIG. 7 shows a functional configuration of the information processing apparatus 100 according to a modified embodiment of the present invention.

### DETAILED DESCRIPTION OF EMBODIMENTS OF THE PRESENT INVENTION

Now, the present invention will be described with reference to its embodiments. However, it should be understood that these embodiments are not intended to limit the present invention set forth in the claims, and not all combinations of features described for the embodiments are essential for the solution according to the invention.

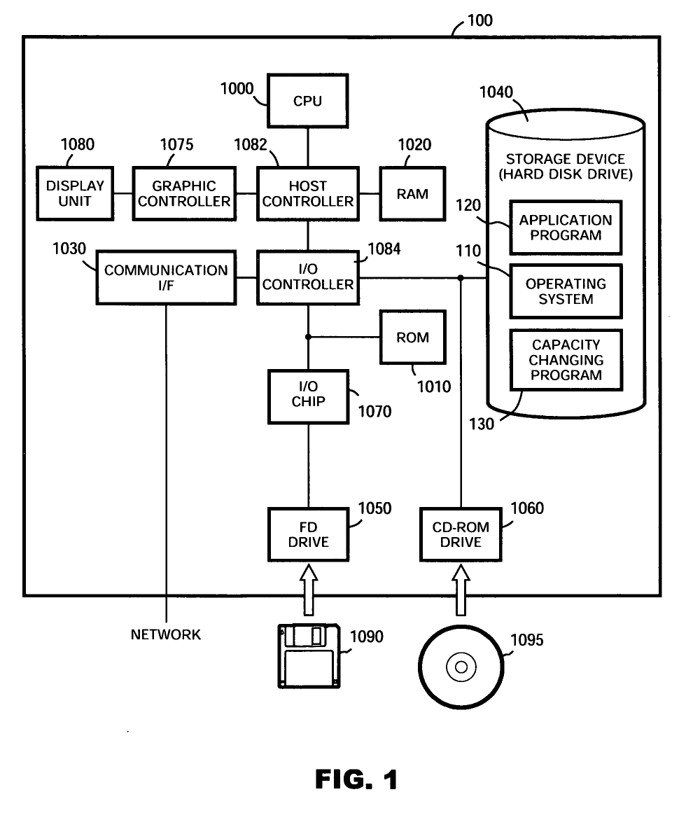

FIG. 1 shows an exemplary hardware configuration of an information processing apparatus 100 according to an embodiment. Installed in the information processing apparatus 100 according to the embodiment are an operating system 110 and an application program 120, as well as a capacity changing program 130. In order to prevent the application program 120 using a storage device from erroneously recognizing that the storage device's free capacity is insufficient, the capacity changing program 130 changes the free capacity of the storage device to be recognized by the application program 120.

The information processing apparatus 100 according to this embodiment includes a CPU peripheral section having a CPU 1000, a RAM 1020, a graphic controller 1075, and a display unit 1080, which are interconnected by a host controller 1082, an I/O section having a communication interface 1030, a storage device 1040, and a CD-ROM drive 1060, which are connected to the host controller 1082 by an I/O controller 1084, and a legacy I/O section having a ROM 1010, a flexible disk drive 1050, and an I/O chip 1070, which are connected to the I/O controller 1084.

The host controller 1082 connects the RAM 1020 with the CPU 1000 and graphic controller 1075, which access the RAM 1020 at a high transfer rate. The CPU 1000 operates in accordance with programs stored in the ROM 1010 and the RAM 1020 and controls each section. The graphic controller 1075 obtains image data generated by, for example, the CPU 1000 on a frame buffer provided in the RAM 1020 and causes the display unit 1080 to display the image data. Alternatively, the graphic controller 1075 may have an internal frame buffer for storing image data generated by the CPU 1000, etc.

The I/O controller 1084 connects the host controller 1082 and the communication interface 1030 with the storage device 1040 and the CD-ROM drive 1060, which are relatively high-speed I/O devices. The communication interface 1030 communicates with other apparatuses over networks. The storage device 1040 stores programs and data used by the CPU 1000 in the information processing apparatus 100. The CD-ROM drive 1060 reads programs or data from a CD-ROM 1095 and provides them to the storage device 1040 through the RAM 1020.

Also connected to the I/O controller 1084 are the ROM 1010 and relatively low-speed I/O devices, such as the flexible disk drive 1050 and the I/O chip 1070. The ROM 1010 stores a boot program executed by the information processing apparatus 100 at a startup time, and programs that depend on the hardware of the information processing apparatus 100. The flexible disk drive 1050 reads programs or data from a flexible disk 1090 and provides them to the storage device 1040 through the RAM 1020. The I/O chip 1070 connects the flexible disk 1090, and various I/O devices through parallel, serial, keyboard, and mouse ports.

Each program to be provided to the storage device 1040 through the RAM 1020 is stored on a recording medium such as the flexible disk 1090, the CD-ROM 1095, or an IC card (not shown), and provided by a user. The program is read from the recording medium, then installed on the storage device 1040 in the information processing apparatus 100 through the RAM 1020, and executed by the CPU 1000.

The storage device 1040, such as a hard disk drive, may have various programs installed on it. These programs include the operating system 110 that provides a basic operational environment for various programs running on the information processing apparatus 100, the application program 120 that runs on the operating system 110 and uses the storage device 1040, and the capacity changing program 130 that causes the information processing apparatus 100 to change the free capacity of the storage device 1040 to be recognized by the application program 120. The application program 120 may be a program such as a word processor or a spreadsheet software program, or alternatively, it may be a setup program for installing an application program.

The above described programs or modules may be stored in external recording media. Besides the flexible disk 1090 and the CD-ROM 1095, the recording media may include optical recording media such as DVD and PD, magneto-optical recording media such as MD, tape media, and semiconductor memory such as IC cards. Additionally, a storage device such as a hard disk or RAM provided in a server system connected to a private communication network or the Internet may be used as the recording medium, and the programs may be provided to the information processing apparatus 100 through the network.

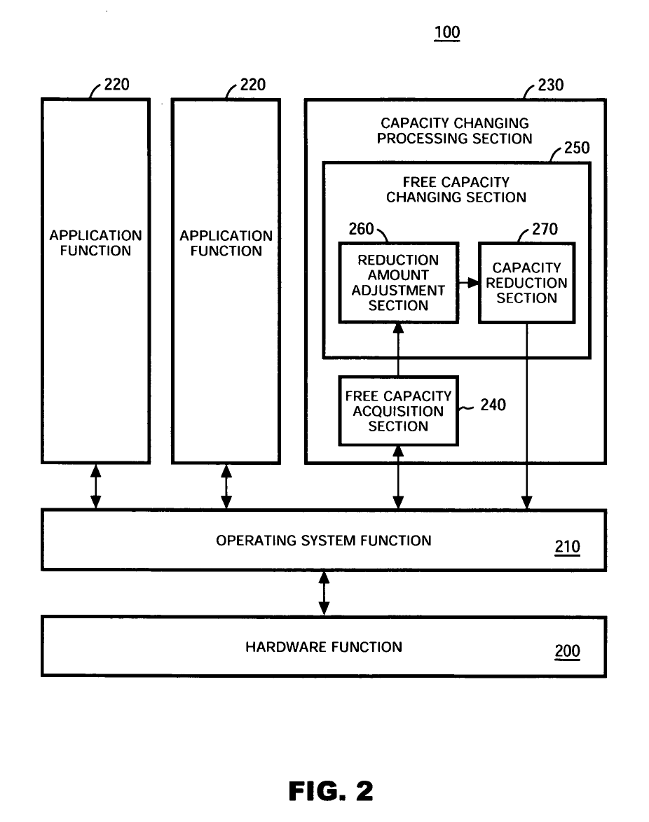

FIG. 2 shows a functional configuration of the information processing apparatus 100, which is provided by running the operating system 110, one or more application programs 120, and the capacity changing program 130 on the information processing apparatus 100. In this functional configuration, the information processing apparatus 100 includes a hardware function 200, an operating system function 210, one or more application functions 220, and a capacity changing processing section 230.

The hardware function 200 consists of hardware resources included in the information processing apparatus 100, such as the CPU 1000, the ROM 1010, the RAM 1020, the communication interface 1030, the storage device 1040, the flexible disk drive 1050, the CD-ROM drive 1060, the I/O chip 1070, the graphic controller 1075, the display unit 1080, and the host controller 1082.

The operating system function 210 is a function provided by running the operating system 110 on the information processing apparatus 100. The operating system function 210 provides, by means of system functions, the basic operational environment in which programs for the application functions 220 and the capacity changing processing section 230 use the hardware function 200. The operating system function 210 receives a request from the application function 220 or the capacity changing processing section 230 for the value of the free capacity of the storage device 1040, and returns the value to the requesting application functions 220 or capacity changing processing section 230. This function may be provided by the information processing apparatus 100 executing a system function such as GetDiskFreeSpaceEx implemented in the operating system 110. The application functions 220 are provided on the information processing apparatus 100 by running the application programs 120 on the information processing apparatus 100.

The capacity changing processing section 230 is a function provided on the information processing apparatus 100 by running the capacity changing program 130 on the information processing apparatus 100. The capacity changing processing section 230 includes a free capacity acquisition section 240 and a free capacity changing section 250. The free capacity acquisition section 240 acquires the value of the free capacity of the storage device 1040 by calling the function of the operating system function 210. The free capacity changing section 250 includes a reduction amount adjustment section 260 and a capacity reduction section 270. The reduction amount adjustment section 260 adjusts a reduction amount, which is the amount to be reduced in the free capacity, based on the free capacity acquired and the free capacity to be recognized by the application function 220. The capacity reduction section 270 changes the free capacity of the storage device 1040 to be recognized by the application function 220 by reducing the free capacity by the reduction amount.

Thus, the capacity changing program 130, which is installed on the information processing apparatus 100 and causes the information processing apparatus 100 to function as the capacity changing processing section 230, includes a free capacity acquisition module and a free capacity changing module. The free capacity changing module includes a reduction amount adjustment module and a capacity reduction module. These program and modules cause the information processing apparatus 100 to function as the free capacity acquisition section 240 and the free capacity changing section 250 including the reduction amount adjustment section 260 and the capacity reduction section 270.

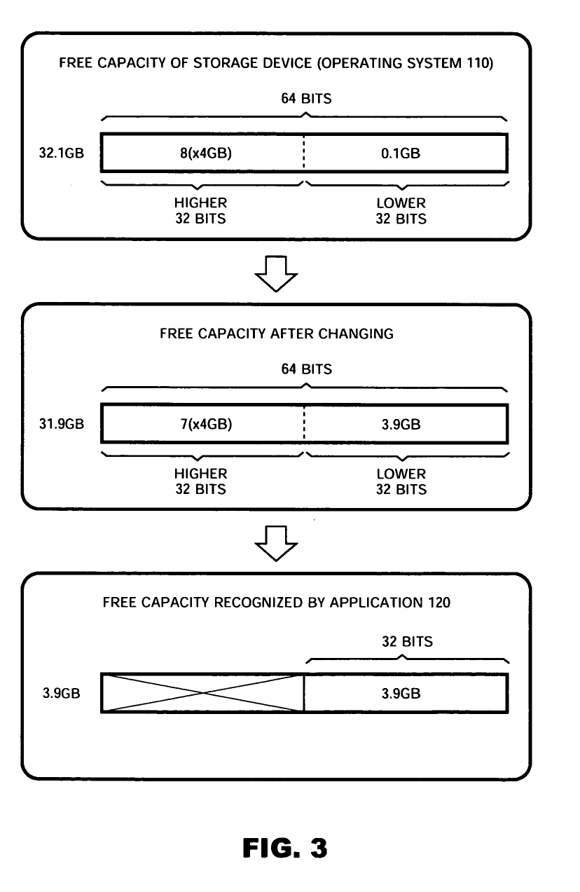

FIG. 3 shows the principle of changing the free capacity by the capacity changing program 130 according to the present embodiment. In this embodiment, the operating system 110 expresses the free capacity of the storage device 1040 as a first integer expression for the information processing apparatus 100, for example a 64-bit integer. On the other hand, the application program 120 recognizes the free capacity as a second integer expression, for example a 32-bit unsigned integer, in which the maximum expressible integer is smaller than the first integer expression.

For example, if the free capacity is 32.1 GB, the higher part (higher 32-bit part) of the 64-bit integer representing the free capacity records a part corresponding to a multiple of 4 GB, that is, eight which is a quotient of the free capacity divided by 4 GB. The lower part (lower 32-bit part) of the 64-bit integer representing the free capacity records a value other than the part corresponding to the multiple of 4 GB, that is, 0.1 GB which is a remainder of the free capacity divided by 4 GB.

When the application program 120 recognizes the free capacity of the storage device 1040 as a 32-bit unsigned integer, it recognizes only the lower part of the 64-bit integer representing the free capacity. That is, the application program 120 recognizes the free capacity of the storage device 1040 as the remainder thereof divided by <the maximum value expressible by the second integer expression+1>. Thus, in this example, the application program 120 will recognize the free capacity as 0.1 GB and stop processing such as storage of a file or installation of an application if the file or application is greater than 0.1 GB.

Accordingly, when the free capacity is a first capacity greater than a first integer (n₁) multiple of a predetermined capacity Hu by a first offset value O₁, the free capacity changing section 250 implemented by the capacity changing program 130 reduces the free capacity to a second capacity calculated by adding to a second integer (n₂) multiple of the predetermined capacity Hu a second offset value O₂ greater than the first offset value O₁ and smaller than the predetermined capacity Hu. That is, the free capacity changing section 250 reduces the free capacity from the first capacity (=Hu′n₁+O₁) to the second capacity (=Hu′n₂+O₂ (O₁<O₂<Hu)). The predetermined capacity Hu is set to a value that is a unit for the higher part of the first integer expression and that is the maximum value of the second integer expression+1. That is, it is set to 4 GB if the second integer expression is a 32-bit unsigned integer.

As a result of this processing, the free capacity changing section 250 reduces the free capacity to the second capacity when it is the first capacity, and allows the application program 120 to recognize that the free capacity has the second offset value. More specifically, the free capacity changing section 250 reduces the first integer expression for the free capacity to the second capacity when it is the first capacity. The free capacity is, therefore, changed to the second capacity so that the application program 120 recognizes that the second integer expression for the free capacity has the second offset value. Thus, the free capacity to be recognized by the application program 120 can be increased from O₁ to O₂.

For example, if the free capacity is a first capacity of 32.1 GB (Hu=4 GB, n₁=8, O₁=0.1 GB), the free capacity changing section 250 reduces the free capacity to a second capacity of 31.9 GB (Hu=4 GB, n₂=7, O₂=3.9 GB). Thus, the free capacity to be recognized by the application program 120 can be increased from 0.1 GB to 3.9 GB.

With the above described processing, the free capacity changing section 250 can change the free capacity to be recognized by the application program 120 from O₁ to O₂. In this manner, the capacity changing program 130 running on the information processing apparatus 100 can prevent the application program 120 from erroneously recognizing that the free capacity of the storage device 1040 is insufficient.

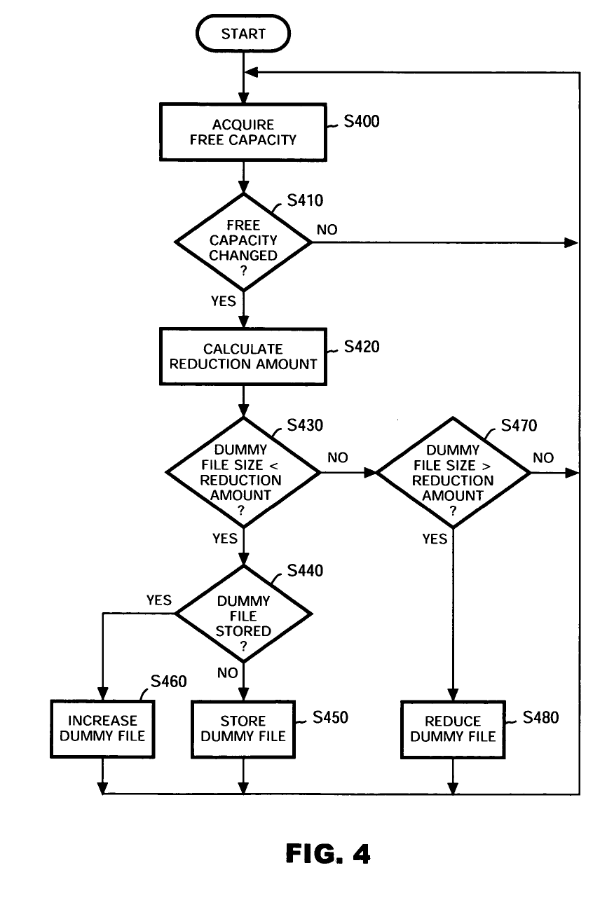

FIG. 4 shows an operational flow of the capacity changing program 130 according to the present embodiment. First, the free capacity acquisition section 240 calls a function provided by the operating system 110 running on the information processing apparatus 100 to acquire the value of the free capacity of the storage device 1040 (S400). If the capacity reduction section 270 has already stored a dummy file in the storage device 1040 in order to reduce the free capacity of the storage device 1040, the free capacity acquisition section 240 acquires the value of the free capacity of the storage device 1040 with the dummy file excluded.

In S400, the free capacity acquisition section 240 may monitor the free capacity of the storage device 1040 at predetermined time intervals. Alternatively, in S400, the free capacity acquisition section 240 may acquire the value of the free capacity of the storage device 1040 when the stored content of the storage device 1040 has been changed. More specifically, the free capacity acquisition section 240 may receive an event notification indicating that the stored content has been changed from the operating system function 210 when, for example, a new file has been written into the storage device 1040, a file stored in the storage device 1040 has been modified due to partial addition or deletion, or a file stored in the storage device 1040 has been deleted. The free capacity acquisition section 240 may then recognize the change in the stored content and acquire the value of the free capacity of the storage device 1040. This allows the capacity changing processing section 230 to operate only when the free capacity needs to be changed so that the hardware resources such as the CPU 1000 are not used wastefully when the free capacity of the storage device 1040 remains unchanged.

If the value of the free capacity has not been changed, the reduction amount adjustment section 260 returns the processing to S400 (S410). If the value of the free capacity has been changed in S410, the reduction amount adjustment section 260 calculates the reduction amount, i.e. the amount to be reduced from the free capacity of the storage device 1040 (S420). For example, if the first capacity (free capacity of the storage device 1040) has the first offset value smaller than a lower threshold below the predetermined capacity, the reduction amount adjustment section 260 calculates the reduction amount by subtracting the second capacity from the first capacity in order to reduce the free capacity to the second capacity. If the first offset value is equal to or greater than the lower threshold, the reduction amount is set to zero so that the free capacity remains to be the first capacity.

A dummy file is a file stored in the storage device 1040 by the capacity reduction section 270 to reduce the free capacity of the storage device 1040. If the size of the dummy file is substantially equal to the reduction amount (S430: No, S470: No), the reduction amount adjustment section 260 returns the processing to S400 to continue monitoring the free capacity.

If the size of the dummy file is smaller than the reduction amount, the reduction amount adjustment section 260 directs the capacity reduction section 270 to increase the size of the dummy file (S430: Yes). Upon receiving this direction, the capacity reduction section 270 stores in the storage device 1040 a dummy file having the size equal to the reduction amount calculated by subtracting the second capacity from the first capacity or free capacity if it has not been stored yet (S440: No) and reduces the free capacity to the second capacity. Here, the reduction amount adjustment section 260 according to the embodiment stores a file smaller than the predetermined capacity as the dummy file in the storage device 1040. The capacity reduction section 270 then returns the processing to S400 to continue monitoring the free capacity.

If the dummy file has already been stored (S440: Yes), the capacity reduction section 270 increases the size of the dummy file to the reduction amount (S460). Here, the capacity reduction section 270 may store a further dummy file in the storage device 1040 so that the total size of the previously stored one or more dummy files and the newly stored dummy file becomes equal to the reduction amount. The capacity reduction section 270 then returns the processing to S400 to continue monitoring the free capacity.

If the size of the dummy file is greater than the reduction amount (S430: No, S470: Yes), the reduction amount adjustment section 260 directs the capacity reduction section 270 to reduce the size of the dummy file. Upon receiving this direction, the capacity reduction section 270 reduces the size of the dummy file to the reduction amount (S480). Here, the capacity reduction section 270 may delete some of the dummy files stored in the storage device 1040 so that the total size of the remaining dummy files becomes equal to the reduction amount. The capacity reduction section 270 then returns the processing to S400 to continue monitoring the free capacity.

With the above described processing in S450, S460, and S480, if the result of monitoring in S400 indicates that the first offset value of the first capacity or free capacity is smaller than the predetermined lower threshold below the predetermined capacity, the reduction amount adjustment section 260 can store a file of the size calculated by subtracting the second capacity from the first capacity in the storage device 1040 to reduce the free capacity to the second capacity.

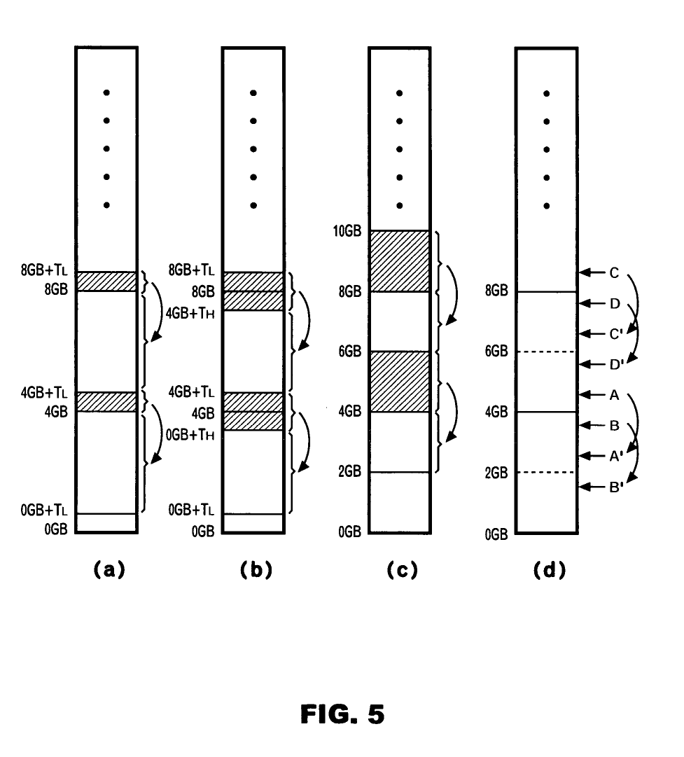

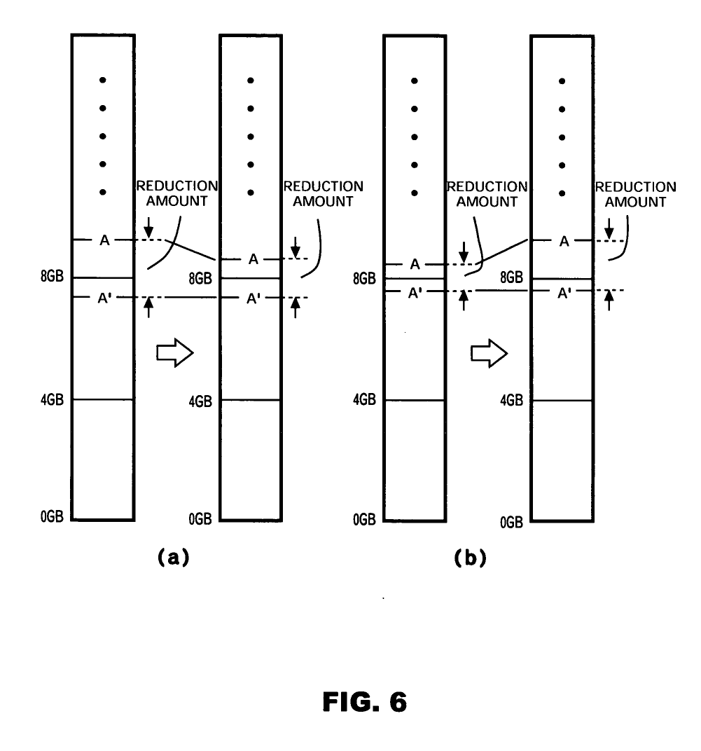

FIGS. 5 and 6 show forms of changing the free capacity by the capacity changing program 130 according to the present embodiment. FIGS. 5(a), 5(b), 5(c), 5(d), 6(a), and 6(b) show first, second, third, fourth, fifth, and sixth forms of changing, respectively.

In the first form of changing (FIG. 5(a)), the first offset value O₁ of the first capacity (free capacity of the storage device 1040) is smaller than a lower threshold T_{L}. Then, the reduction amount adjustment section 260 in the free capacity changing section 250 sets the reduction amount to reduce the free capacity to the second capacity having the second offset value O₂ greater than the first offset value O₁ and smaller than the predetermined capacity Hu (S400 in FIG. 4). The lower threshold TL has a predetermined value below the predetermined capacity Hu. The capacity reduction section 270 in the free capacity changing section 250 then stores in the storage device 1040 a dummy file of the size equal to the reduction amount to reduce the free capacity of the storage device 1040 to the second capacity (S450, S460, or S480 in FIG. 4).

More preferably, as shown in FIG. 5(a), the free capacity changing section 250 reduces the free capacity to the second capacity having the second offset value O₂ equal to or greater than the lower threshold T_{L} and smaller than the predetermined capacity Hu. The free capacity changing section 250 selects the value of the second capacity so that the second offset value O₂ becomes smaller than but close to the predetermined capacity Hu in order to maximize the free capacity to be recognized by the application program 120.

In this manner, if the lower threshold T_{L} is 0.1 GB and the free capacity of the storage device 1040 to be recognized by the application program 120 is smaller than 0.1 GB, for example, the free capacity changing section 250 can change the free capacity to be recognized by the application program 120 to 0.1 GB or more.

In the second form of changing (FIG. 5(b)), the first offset value O₁ of the first capacity (free capacity of the storage device 1040) is smaller than a lower threshold T_{L}, or the first offset value O₁ is greater than a higher threshold T_{H}. Then, the reduction amount adjustment section 260 in the free capacity changing section 250 sets the reduction amount to reduce the free capacity to the second capacity having the second offset value O₂ between the lower threshold T_{L} and the higher threshold T_{H} inclusive (S400 in FIG. 4). The lower threshold T_{L} has a predetermined value below the predetermined capacity Hu, and the higher threshold T_{H} has a value equal to or above the lower threshold T_{L} and below the predetermined capacity Hu. The capacity reduction section 270 in the free capacity changing section 250 then stores in the storage device 1040 a dummy file of the size equal to the reduction amount to reduce the free capacity of the storage device 1040 to the second capacity (S450, S460, or S480 in FIG. 4). The free capacity changing section 250 selects the value of the second capacity so that the second offset value O₂ becomes equal to the higher threshold T_{H} or smaller than but close to the higher threshold T_{H} in order to maximize the free capacity to be recognized by the application program 120.

In this manner, if the lower threshold T_{L} is 0.1 GB and the higher threshold T_{H} is 3.9 GB, and if the free capacity of the storage device 1040 to be recognized by the application program 120 is smaller than 0.1 GB or greater than 3.9 GB, for example, the free capacity changing section 250 can change the free capacity to be recognized by the application program 120 to a capacity between 0.1 GB and 3.9 GB inclusive. Keeping the free capacity equal to or smaller than the higher threshold in this manner can reduce the possibility that the free capacity to be recognized by the application program 120 becomes smaller than the lower threshold T_{L} even when the free capacity of the storage device 1040 instantaneously increases.

In the third form of changing (FIG. 5(c)), the first offset value O₁ of the first capacity (free capacity of the storage device 1040) is smaller than half of the predetermined capacity Hu. Then, the reduction amount adjustment section 260 in the free capacity changing section 250 sets the reduction amount to reduce the free capacity to the second capacity having the second offset value O₂ equal to or greater than half of the predetermined capacity Hu and smaller than the predetermined capacity Hu (S400 in FIG. 4). The capacity reduction section 270 in the free capacity changing section 250 then stores in the storage device 1040 a dummy file of the size equal to the reduction amount to reduce the free capacity of the storage device 1040 to the second capacity (S450, S460, or S480 in FIG. 4).

For example, assuming that the predetermined capacity Hu is 4 GB, and the first offset value O₁ is smaller than half of the predetermined capacity Hu, that is, the first capacity or free capacity is equal to or greater than 4 GB and smaller than 6 GB, equal to or greater than 8 GB and smaller than 10 GB,-, the free capacity changing section 250 sets the free capacity to equal to or greater than 2 GB and smaller than 4 GB, equal to or greater than 6 GB and smaller than 8 GB,-, respectively. As a result, the free capacity of the storage device 1040 to be recognized by the application program 120 is changed from the amount smaller than 2 GB to the amount equal to or greater than 2 GB and smaller than 4 GB.

In this manner, when the free capacity of the storage device 1040 to be recognized by the application program 120 is smaller than half of the predetermined capacity Hu, the free capacity changing section 250 can keep the free capacity equal to or greater than half of the predetermined capacity Hu.

In the fourth form of changing (FIG. 5(d)), when the free capacity of the storage device 1040 is the first capacity, the reduction amount adjustment section 260 in the free capacity changing section 250 sets the reduction amount to reduce the free capacity to the second capacity having the second offset value O₂ that is closer to half of the predetermined capacity Hu compared with the first offset value O₁ (S400 in FIG. 4). The capacity reduction section 270 in the free capacity changing section 250 then stores in the storage device 1040 a dummy file of the size equal to the reduction amount to reduce the free capacity of the storage device 1040 to the second capacity (S450, S460, or S480 in FIG. 4). In this manner, the free capacity changing section 250 can keep the free capacity of the storage device 1040 to be recognized by the application program 120 about half of the predetermined capacity Hu.

In the fifth form of changing (FIG. 6(a)), when the free capacity of the storage device 1040 is the first capacity, the capacity reduction section 270 in the free capacity changing section 250 eliminates from the free capacity a reduction amount calculated by subtracting the second capacity from the first capacity to change the free capacity to the second capacity (S450, S460, or S480 in FIG. 4). When the free capacity further decreases and approaches the first multiple of the predetermined capacity Hu, the reduction amount adjustment section 260 in the free capacity changing section 250 reduces the reduction amount so that the reduction in the second capacity becomes relatively small as compared with the reduction in the first capacity (S400 in FIG. 4).

For example, assuming that the predetermined capacity Hu is 4 GB and the first capacity or free capacity is 8 GB+O₁ (shown as A), the capacity reduction section 270 reduces the free capacity to the second capacity, 4 GB+O₂ (shown as A′). When the free capacity further decreases and approaches 8 GB, and therefore the first offset value O₁ decreases, the reduction amount adjustment section 260 reduces the reduction amount so that the reduction in the second capacity and the second offset value O₂ becomes relatively small as compared with the reduction in the first capacity and the first offset value O₁. More preferably, when the free capacity further decreases and approaches the first multiple of the predetermined capacity Hu, the reduction amount adjustment section 260 reduces the reduction amount by the amount of decrease in the free capacity to keep the second capacity and the second offset value O₂ constant.

In this manner, the free capacity changing section 250 can keep the free capacity of the storage device 1040 to be recognized by the application program 120 relatively large even when the first capacity or free capacity decreases.

In the sixth form of changing (FIG. 6(b)), when the free capacity of the storage device 1040 is the first capacity, the capacity reduction section 270 in the free capacity changing section 250 eliminates from the free capacity a reduction amount calculated by subtracting the second capacity from the first capacity and changes the free capacity to the second capacity (S450, S460, or S480 in FIG. 4). When the free capacity further increases, the reduction amount adjustment section 260 in the free capacity changing section 250 increases the reduction amount so that the increase in the second capacity becomes relatively small as compared with the increase in the first capacity (S400 in FIG. 4).

For example, assuming that the predetermined capacity Hu is 4 GB and the first capacity (free capacity) is 8 GB+O₁ (shown as A), the capacity reduction section 270 reduces the free capacity to the second capacity, 4 GB+O₂ (shown as A′). When the free capacity further increases and therefore the first offset value O₁ increases, the reduction amount adjustment section 260 increases the reduction amount so that the increase in the second capacity and the second offset value O₂ becomes relatively small as compared with the increase in the first capacity and the first offset value O₁. More preferably, when the free capacity further increases, the reduction amount adjustment section 260 increases the reduction amount by the amount of increase in the free capacity to keep the second capacity and the second offset value O₂ constant.

The reduction amount adjustment section 260 may perform the above processing until the first offset value O₁ of the first capacity or free capacity increases to exceed a lower threshold T_{L} below the predetermined capacity Hu. When the first offset value O₁ increases to exceed the lower threshold T_{L}, the reduction amount adjustment section 260 may set the reduction amount to zero. As a result, the capacity reduction section 270 can cause the application program 120 to recognize the free capacity exceeding the lower threshold T_{L}, by deleting the dummy file and providing the second capacity equal to the first capacity or free capacity to the application program 120.

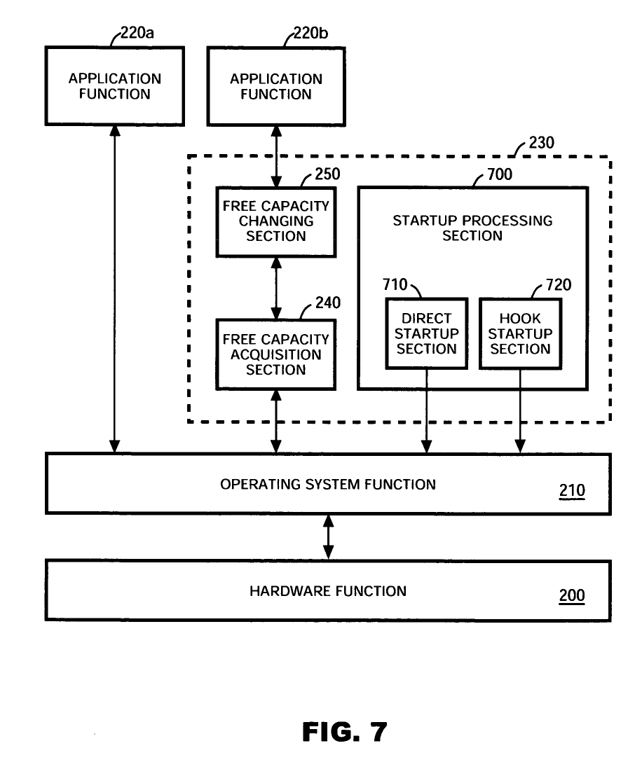

FIG. 7 shows a functional configuration of the information processing apparatus 100 according to a modified embodiment, which is implemented by running the operating system 110, one or more application programs 120, and the capacity changing program 130 on the information processing apparatus 100. In this functional configuration, the information processing apparatus 100 includes a hardware function 200, an operating system function 210, application functions 220a and 220b, and a capacity changing processing section 230. The operations of the hardware function 200, the operating system function 210, and the application functions 220a and 220b are similar to those of the hardware function 220, the operating system function 210, and the application functions 220 shown in FIG. 2, respectively. Therefore, they will be described only with respect to what is different from those shown in FIG. 2.

In this modified embodiment, the application function 220a can recognize the free capacity of the storage device 1040 directly as the one expressed by the operating system function 210. On the other hand, the application function 220b recognizes the free capacity of the storage device 1040 as the second integer expression like the application functions 220 shown in FIG. 2. As a result, it recognizes the free capacity of the storage device 1040 as a remainder using the predetermined capacity.

The capacity changing processing section 230 is a function implemented in the information processing apparatus 100 by running the capacity changing program 130 on the information processing apparatus 100. The capacity changing processing section 230 includes a free capacity acquisition section 240, a free capacity changing section 250, and a startup processing section 700. In this modified embodiment, a set of the free capacity acquisition section 240 and the free capacity changing section 250 in the capacity changing processing section 230 is called by the application function 220b when it requests acquisition of the value of the free capacity.

When the free capacity acquisition section 240 is called by the application function 220b, it calls the function of the operating system function 210 or operating system 110 running on the information processing apparatus 100, and acquires the value of the free capacity. When the value acquired from the operating system 110 is the first capacity, the free capacity changing section 250 returns to the application function 220b executing the application program 120 the value of the free capacity reduced to the second capacity as a return value for the free capacity of the storage device 1040. In this modified embodiment, the free capacity changing section 250 may include a reduction amount adjustment section 260 and a capacity reduction section 270 having functions similar to those of the reduction amount adjustment section 260 and the capacity reduction section 270 shown in FIG. 2, respectively, and calculate the reduction amount to reduce the free capacity to the second capacity in the same manner as the reduction amount adjustment section 260 and the capacity reduction section 270 shown in FIG. 2.

The reduction amount adjustment section 260 according to this modified embodiment does not monitor the free capacity of the storage device 1040, and operates when called by the application function 220b. In addition, the capacity reduction section 270 according to this modified embodiment may apparently reduce the free capacity of the storage device 1040 by changing the value of the free capacity to be returned to the application function 220b, rather than storing a dummy file in the storage device 1040. In this case, instead of S430, S440, S450, S460, S470, and S480 in FIG. 4, the capacity reduction section 270 returns a value calculated by subtracting the reduction calculated in S420 from the free capacity to the application function 220b as the free capacity of the storage device 1040.

The startup processing section 700 causes the information processing apparatus 100 to start the respective application programs 120 so that they operate as the application functions 220a and 220b. The startup processing section 700 may be implemented by, for example, a batch file that sequentially starts the application programs 120. The startup processing section 700 includes a direct startup section 710 and a hook startup section 720.

The direct startup section 710 starts a first application program 120 to cause it to acquire the value of the free capacity by calling the function of the operating system 110 from the application function 220a executing the first application program 120 when the application function 220a executing the first application program 120 that recognizes the free capacity greater than the predetermined capacity Hu requests acquisition of the free capacity greater than the predetermined capacity Hu. For example, the direct startup section 710 may be implemented by a command line for starting the first application program 120, which is included in the batch file implementing the startup processing section 700.

The hook startup section 720 starts a second application program 120 to cause it to acquire the free capacity changed by and outputted from the free capacity changing section 250 by calling the capacity changing program 130 from the application function 220b executing the second application program 120 when the application function 220b executing the second application program 120 that recognizes the free capacity of the storage device 1040 as a remainder using the predetermined capacity Hu request acquisition of the value of the free capacity. For example, the hook startup section 720 may be implemented by a command line included in the batch file implementing the startup processing section 700. The command line may include a command for starting the application function 220b, the free capacity acquisition section 240, and the free capacity changing section 250 in such a manner that the system function call from the application function 220b is hooked by the free capacity acquisition section 240 and the free capacity changing section 250 in the capacity changing processing section 230.

Thus, the capacity changing program 130, which is installed on the information processing apparatus 100 and causes the information processing apparatus 100 to function as the capacity changing processing section 230, includes a free capacity acquisition module and a free capacity changing module. The free capacity changing module includes a reduction amount adjustment module and a capacity reduction module. These program and modules cause the information processing apparatus 100 to function as the free capacity acquisition section 240 and the free capacity changing section 250 including the reduction amount adjustment section 260 and the capacity reduction section 270. The capacity changing program 130 further includes a startup program for causing the information processing apparatus 100 to function as the startup processing section 700.

With the functional configuration of the information processing apparatus 100 according to the modified embodiment described above, the capacity changing program 130 can change the free capacity for recognition only by the application program 120 that does not correctly recognize the free capacity equal to or greater than the predetermined capacity. In addition, the free capacity changing section 250 can change the value of the free capacity to be recognized by the application function 220b without storing the dummy file in the storage device 1040. This can prevent an increase in processing load on the information processing apparatus 100 that would be caused by storing the dummy file.

While the present invention has been described with respect to the embodiments, the technical scope of the present invention is not limited to the above embodiments. It will be apparent to those skilled in the art that various modifications and alterations may be made to the above embodiments, and those embodiments with such modifications and alterations may also fall within the technical scope of the present invention.

For example, the functions of the free capacity acquisition section 240 and the free capacity changing section 250 shown in FIGS. 2 and 7 may be implemented as part of the operating system function 210. In addition, the capacity reduction section 270 in the free capacity changing section 250 may change the free capacity of the storage device 1040 by changing the number of resident programs residing and running on the information processing apparatus 100 and/or the size of the memory area reserved by such resident programs to change the size of a page file that the operating system 110 stores in the storage device 1040, rather than storing the dummy file in the storage device 1040.

1. A method comprising:
acquiring a free capacity of a storage device associated with an information processing apparatus; and
in response to said free capacity being greater than a first integer multiple of a predetermined capacity by a first offset amount, changing said free capacity to an altered free capacity where said altered free capacity is calculated by adding a second offset amount to a second multiple of said predetermined capacity, where said second offset amount is greater than said first offset amount and less than said predetermined capacity.

2. The method in accordance with claim 1, wherein:
an application program executing on said information processing apparatus recognizes said free capacity of said storage device as a remainder of the free capacity divided by said predetermined capacity, and
said altered free capacity causes said application program to recognize said second offset amount as a measure of free space on said storage device.

3. The method in accordance with claim 1, wherein:
said free capacity is changed to said altered free capacity only when said first offset amount is less than a predetermined lower threshold below said predetermined capacity.

4. The method in accordance with claim 1, wherein said first multiple is greater than said second multiple.

5. The method in accordance with claim 1 wherein changing said free capacity to an altered free capacity comprises;
storing a file in said storage device, said file having a size substantially equal to a difference between said free capacity and said altered free capacity.

6. The method in accordance with claim 3, further comprising:
monitoring said free capacity of said storage device at predetermined time intervals, and
in response to a finding by said monitoring that said first offset amount of said free capacity has become smaller than said predetermined lower threshold, changing said free capacity to said altered free capacity by storing a file in said storage device, said file having a size substantially equal to a difference between said free capacity and said altered free capacity.

7. The method of claim 1, wherein said free capacity of said storage device is acquired whenever the contents stored in said storage device is changed.

8. The method in accordance with claim 2, wherein;
said free capacity of said storage device is acquired in response to a request by said application program for said free capacity value; and
wherein changing said free capacity to said altered free capacity comprises calculating said altered free capacity and returning said altered free capacity to said application program as a return value for said request.

9. The method of claim 8 wherein acquiring said free capacity of said storage device comprises calling a function of an operating system executing on said information processing apparatus.

10. The method of claim 1 wherein said free capacity is changed to said altered free capacity when said first offset amount is (i) less than a predetermined lower threshold below said predetermined capacity, or (ii) greater than a predetermined higher threshold which is equal to or greater than said lower threshold, and wherein said second offset amount is between said lower threshold and said higher threshold, inclusive.

11. The method in accordance with claim 1, wherein;
in response to said first offset amount being less than half of said predetermined capacity, said second offset amount is equal to or greater than half of said predetermined capacity and smaller than said predetermined capacity.

12. An information processing apparatus comprising:
a storage device;
a free capacity acquisition module for acquiring a free capacity of said storage device;
a free capacity alteration module for, in response to said free capacity being greater than a first integer multiple of a predetermined capacity by a first offset amount, changing said free capacity to an altered free capacity where said altered free capacity is calculated by adding a second offset amount to a second multiple of said predetermined capacity, where said second offset amount is greater than said first offset amount and less than said predetermined capacity and where said first multiple is greater than said second multiple.

13. The apparatus in accordance with claim 12, further comprising at least one application program executing on said information processing apparatus, which program recognizes said free capacity of said storage device as a remainder of the free capacity divided by said predetermined capacity, and wherein;
said altered free capacity causes said application program to recognize said second offset amount as a measure of free space on said storage device.

14. The apparatus in accordance with claim 12, wherein:
said free capacity alteration module only changes said free capacity to said altered free capacity in response to said first offset amount being less than a predetermined lower threshold below said predetermined capacity.

15. The apparatus in accordance with claim 12 wherein said free capacity alteration module changes said free capacity to said altered free capacity by storing a file in said storage device, said file having a size substantially equal to a difference between said free capacity and said altered free capacity.

16. The apparatus in accordance with claim 14, wherein:
said free capacity acquisition module monitors said free capacity of said storage device at predetermined time intervals, and wherein;
said free capacity alteration module, in response to a finding during said monitoring that said first offset amount has become smaller than said predetermined lower threshold, changes said free capacity to said altered free capacity by storing a file in said storage device, said file having a size substantially equal to a difference between said free capacity and said altered free capacity.

17. The apparatus of claim 12, wherein said free capacity acquisition module acquires said free capacity of said storage device whenever the contents stored in said storage device is changed.

18. The apparatus in accordance with claim 13, wherein;
said free capacity acquisition module acquires said free capacity of said storage device in response to a request by said application program for said free capacity value; and
wherein said free capacity alteration module changes said free capacity to said altered free capacity by calculating said altered free capacity and returning said altered free capacity to said application program as a return value for said request.

19. The apparatus of claim 12 wherein said free capacity alteration module changes said free capacity to said altered free capacity when said first offset amount is (i) less than a predetermined lower threshold below said predetermined capacity, or (ii) greater than a predetermined higher threshold which is equal to or greater than said lower threshold, and wherein said second offset amount is between said lower threshold and said higher threshold, inclusive.

20. The apparatus in accordance with claim 12, wherein;
said free capacity alteration module, in response to said first offset amount being less than half of said predetermined capacity, calculates said second offset amount as an amount equal to or greater than half of said predetermined capacity and smaller than said predetermined capacity.

21. A computer readable storage medium having embodied thereon computer readable program instructions effective when executing on an information processing apparatus to:
acquire a free capacity of a storage device associated with said information processing apparatus; and
change said free capacity, in response to said free capacity being greater than a first integer multiple of a predetermined capacity by a first offset amount, to an altered free capacity where said altered free capacity is calculated by adding a second offset amount to a second multiple of said predetermined capacity, where said second offset amount is greater than said first offset amount and less than said predetermined capacity and where said first multiple is greater than said second multiple.

22. The storage medium in accordance with claim 21, wherein:
said program instructions are effective when executing to change said free capacity to said altered free capacity only when said first offset amount is less than a predetermined lower threshold below said predetermined capacity.

23. The storage medium in accordance with claim 21 wherein said program instructions are effective when executing to change said free capacity to said altered free capacity by storing a file in said storage device, said file having a size substantially equal to a difference between said free capacity and said altered free capacity.

24. The storage medium in accordance with claim 22, further comprising program instuctions effective when executing to monitor said free capacity of said storage device at predetermined time intervals, and wherein;
said program instructions are effective when executing to, in response to a finding during said monitoring that said first offset amount of said free capacity has become smaller than said predetermined lower threshold, change said free capacity to said altered free capacity by storing a file in said storage device, said file having a size substantially equal to a difference between said free capacity and said altered free capacity.

25. The storage medium in accordance with claim 21, wherein said program instructions are effective when executing to:
acquire said free capacity of said storage device in response to a request by an application program executing on said information processing apparatus for said free capacity value; and
change said free capacity to said altered free capacity by calculating said altered free capacity and returning said altered free capacity to said application program as a return value for said request.

26. The storage medium in accordance with claim 21, wherein said program instructions are effective when executing to, in response to said first offset amount being less than half of said predetermined capacity, calculate said second offset amount as equal to or greater than half of said predetermined capacity and smaller than said predetermined capacity.
